(19) United States
(12) Patent Application Publication
(10) Pub. No.: US 2020/0090046 A1
(43) Pub. Date: Mar. 19, 2020

(54) SYSTEM AND METHOD FOR CASCADED DYNAMIC MAX POOLING IN NEURAL NETWORKS

(71) Applicant: Huawei Technologies Co., Ltd., Shenzhen (CN)

(72) Inventors: Serdar Sozubek, North York (CA); John Joseph, Shenzhen (CN)

(21) Appl. No.: 16/131,826

(22) Filed: Sep. 14, 2018

(51) Int. Cl. G06N 3/08; G06N 3/04; G06F 17/16

(52) U.S. Cl. CPC G06N 3/084; G06F 17/16; G06N 3/04

(57) ABSTRACT

A method for performing size K×K max pooling with stride S at a max pooling layer of a convolutional neural network to downsample input data includes receiving input data, buffering the input data, applying a cascade of size 2×2 max pooling stages to the buffered input data to generate downsampled output data, wherein a stride value of each size 2×2 max pooling stage is determined dynamically in accordance with pooling parameters associated with the size 2×2 max pooling stage.

### TECHNICAL FIELD

The present disclosure relates generally to a system and method for data processing, and, in particular embodiments, to a system and method for cascaded dynamic max pooling in neural networks.

### BACKGROUND

Neural networks (NNs) are computing systems that are inspired by how biological brains operate. NNs can learn to perform tasks, such as object detection, image recognition, voice recognition, or pattern recognition, by considering examples. NNs typically do not need to be programmed with any task-specific rules. Instead, NNs learn identifying characteristics from the examples they process.

Convolutional neural networks (CNNs) are a sub-class of feed forward NNs that have distinct logical representations of computational layers optimized for tasks such as image classification. When used for image classification, CNNs can learn to identify features of an image, such as visual objects. The learning step is formally known as training where a given neural network is input a reference input dataset comprising input data representative of images which are known to contain some desired visual objects of interest. Once training is complete, the NN can be deployed to detect the visual objects of interest from images input to the trained CNN. This phase formerly referred to as inference.

CNNs may have significant resource (e.g., compute resources and memory resources) requirements, especially during training. Therefore, there is a need for a system and method for reducing resource requirements in NNs, and particularly, CNNs.

### SUMMARY

Example embodiments provide a system and method for cascaded dynamic max pooling in neural networks.

In accordance with an aspect of the present disclosure, a computer-implemented method is provided for performing size K×K max pooling with stride S at a max pooling layer of a convolutional neural network to downsample input data. The computer-implemented method includes receiving, at the max pooling layer, input data, buffering, at the max pooling layer, the input data, applying, at the max pooling layer, a cascade of size 2×2 max pooling stages to the buffered input data to generate downsampled output data, wherein a stride value of each size 2×2 max pooling stage is determined dynamically in accordance with pooling parameters associated with the size 2×2 max pooling stage, and outputting, by the max pooling layer, the downsampled output data to another layer of the convolution neural network for further processing.

Optionally, in any of the preceding aspects, the pooling parameters associated with the size 2×2 max pooling stage comprises at least one of a size of input data at the size 2×2 max pooling stage, a window size of the size 2×2 max pooling stage, or an overlap between neighboring windows of the size 2×2 max pooling stage.

Optionally, in any of the preceding aspects, the overlap between the neighboring windows of the size 2×2 max pooling stage is determined in accordance with the size of the input data at the size 2×2 max pooling stage, and the window size of the size 2×2 max pooling stage.

Optionally, in any of the preceding aspects, applying the cascade of size 2×2 max pooling stages includes determining, by the max pooling layer, a size of the buffered input data and a final size of the downsampled output, determining, by the max pooling layer, an overlap between neighboring windows of input data of a first size 2×2 max pooling stage in the cascade of size 2×2 max pooling stages, and a window size of the input data of the first size 2×2 max pooling stage, determining, by the max pooling layer, a stride S of the first size 2×2 max pooling stage in accordance with the overlap, and the window size, applying, by the max pooling layer, the size 2×2 max pooling with the stride S kernel to the input data of the first size 2×2 max pooling stage to generate intermediate downsampled output data, saving, by the max pooling layer, the intermediate downsampled output data, and adjusting, by the max pooling layer, the size of input data at the first size 2×2 max pooling stage, the window size of the first size 2×2 max pooling stage, and the overlap between neighboring windows of the first size 2×2 max pooling stage.

Optionally, in any of the preceding aspects, determining the stride S of the first size 2×2 max pooling stage includes determining, by the max pooling layer, that the overlap between neighboring windows of the input data at the first size 2×2 max pooling stage is equal to zero, and based thereon setting, by the max pooling layer, the stride S to two, determining, by the max pooling layer, that the overlap between neighboring windows of the input data at the first size 2×2 max pooling stage is a first even value and the window size of the first size 2×2 max pooling stage is a second even value, and based thereon setting, by the max pooling layer, the stride S to two, and setting, by the max pooling layer, the stride S to one for any other possible values of the overlap between neighboring windows of the input data at the first size 2×2 max pooling stage and the window size of the first size 2×2 max pooling stage.

Optionally, in any of the preceding aspects, the computer-implemented method further includes determining that the overlap between neighboring windows of the input data at the first size 2×2 max pooling stage is equal to zero and the window size is an odd value, and based thereon adding, by the max pooling layer, a padding element to each window sized segment of the input data at the first size 2×2 max pooling stage, and adjusting, by the max pooling layer, the window size and the size of the input data at the first size 2×2 max pooling stage.

Optionally, in any of the preceding aspects, adjusting the window size and the size of the input data at the first size 2×2 max pooling stage includes incrementing, by the max pooling layer, the window size, and adjusting, by the max pooling layer, the size of the input data at the first size 2×2 max pooling stage in accordance with expression size=size+(size/the window size).

Optionally, in any of the preceding aspects, adjusting the size of the input data at the first size 2×2 max pooling stage, the window size, and the overlap includes adjusting, by the max pooling layer, the window size in accordance with expression window size=(window size−2)/stride S+1, adjusting, by the max pooling layer, the size of the input data at the first size 2×2 max pooling stage in accordance with expression size=(size−2)/stride S+1, and adjusting, by the max pooling layer, the overlap in accordance with expression overlap=(overlap−2)/2+1.

Optionally, in any of the preceding aspects, the computer-implemented method comprising repeating, by the max pooling layer, the determining the stride S, the applying, the saving, and the adjusting until a size of input data at remaining size 2×2 max pooling stages is equal to the final size.

In accordance with another aspect of the present disclosure, a device for performing size K×K max pooling with stride S at a max pooling layer of a convolutional neural network to downsample input data is provided. The device includes a non-transitory memory storage comprising instructions, and one or more processors in communication with the memory storage. Therein the one or more processors execute the instructions to receive input data, buffer the input data, apply a cascade of size 2×2 max pooling stages to the buffered input data to generate downsampled output data, wherein a stride value of each size 2×2 max pooling stage is determined dynamically in accordance with pooling parameters associated with the size 2×2 max pooling stage, and output the downsampled output data to another layer of the convolution neural network for further processing.

Optionally, in any of the preceding aspects, the pooling parameters associated with the size 2×2 max pooling stage comprises at least one of a size of input data at the size 2×2 max pooling stage, a window size of the size 2×2 max pooling stage, or an overlap between neighboring windows of the size 2×2 max pooling stage.

Optionally, in any of the preceding aspects, the overlap between the neighboring windows of the size 2×2 max pooling stage is determined in accordance with the size of the input data at the size 2×2 max pooling stage, and the window size of the size 2×2 max pooling stage.

Optionally, in any of the preceding aspects, the one or more processors further execute instructions to determine a size of the buffered input data and a final size of the downsampled output, determine an overlap between neighboring windows of input data of a first size 2×2 max pooling stage in the cascade of size 2×2 max pooling stages, and a window size of the input data of the first size 2×2 max pooling stage, determine a stride S of the first size 2×2 max pooling stage in accordance with the overlap, and the window size, apply the size 2×2 max pooling with stride S kernel to the input data of the first size 2×2 max pooling stage to generate intermediate downsampled output data, save the intermediate downsampled output data, and adjust the size of the input data at the first size 2×2 max pooling stage, the window size of the first size 2×2 max pooling stage, and the overlap between neighboring windows of the first size 2×2 max pooling stage.

Optionally, in any of the preceding aspects, the one or more processors further execute instructions to determine that the overlap between neighboring windows of the input data at the first size 2×2 max pooling stage is equal to zero, and based thereon set the stride S to two, determine that the overlap between neighboring windows of the input data at the first size 2×2 max pooling stage is a first even value and the window size of the first size 2×2 max pooling stage is a second even value, and based thereon set the stride S to two, and set the stride S to one for any other possible values of the overlap between neighboring windows of the input data at the first size 2×2 max pooling stage and the window size of the first size 2×2 max pooling stage.

Optionally, in any of the preceding aspects, the one or more processors further execute instructions to determine that the overlap between neighboring windows of the input data at the first size 2×2 max pooling stage is equal to zero and the window size is an odd value, and based thereon add a padding element to each window sized segment of the input data at the first size 2×2 max pooling stage, and adjust the window size and the size of the input data at the first size 2×2 max pooling stage.

Optionally, in any of the preceding aspects, the one or more processors further execute instructions to increment the window size, and adjust the size of the input data at the first size 2×2 max pooling stage in accordance with expression size=size+(size/the window size).

Optionally, in any of the preceding aspects, the one or more processor further execute instructions to adjust the window size in accordance with expression window size=(window size−2)/stride S+1, adjust the size of the input data at the first size 2×2 max pooling stage in accordance with expression size=(size−2)/stride S+1, and adjust the overlap in accordance with expression overlap=(overlap−2)/2+1.

Optionally, in any of the preceding aspects, the one or more processors further execute instructions to repeat the determining the stride S, the applying, the saving, and the adjusting until a size of input data at remaining size 2×2 max pooling stages is equal to the final size.

Optionally, in any of the preceding aspects, the device comprises a convolutional neural network (CNN).

Optionally, in any of the preceding aspects, the device comprises a graphics processing unit with a CNN.

In accordance with another aspect of the present disclosure, a non-transitory computer-readable media storing computer instructions for performing size K×K max pooling with stride S at a max pooling layer of a convolutional neural network to downsample input data is provided. When executed by one or more processors, cause the one or more processors to perform the steps of receive input data, buffer the input data, apply a cascade of size 2×2 max pooling stages to the buffered input data to generate downsampled output data, wherein a stride value of each size 2×2 max pooling stage is determined dynamically in accordance with pooling parameters associated with the size 2×2 max pooling stage, and output the downsampled output data to another layer of the convolution neural network for further processing.

Optionally, in any of the preceding aspects, the pooling parameters associated with the size 2×2 max pooling stage comprises at least one of a size of input data at the size 2×2 max pooling stage, a window size of the size 2×2 max pooling stage, or an overlap between neighboring windows of the size 2×2 max pooling stage.

Optionally, in any of the preceding aspects, the one or more processors further execute instructions to determine a size of the buffered input data and a final size of the downsampled output, determine an overlap between neighboring windows of input data of a first size 2×2 max pooling stage in the cascade of size 2×2 max pooling stages, and a window size of the input data of the first size 2×2 max pooling stage, determine a stride S of the first size 2×2 max pooling stage in accordance with the overlap, and the window size, apply the size 2×2 max pooling with stride S kernel to the input data of the first size 2×2 max pooling stage to generate intermediate downsampled output data, save the intermediate downsampled output data, and adjust the size of the input data at the first size 2×2 max pooling stage, the window size of the first size 2×2 max pooling stage, and the overlap between neighboring windows of the first size 2×2 max pooling stage.

Optionally, in any of the preceding aspects, the one or more processors further execute instructions to determine that the overlap between neighboring windows of the input data at the first size 2×2 max pooling stage is equal to zero, and based thereon set the stride S to two, determine that the overlap between neighboring windows of the input data at the first size 2×2 max pooling stage is a first even value and the window size of the first size 2×2 max pooling stage is a second even value, and based thereon set the stride S to two, and set the stride S to one for any other possible values of the overlap between neighboring windows of the input data at the first size 2×2 max pooling stage and the window size of the first size 2×2 max pooling stage.

Optionally, in any of the preceding aspects, the one or more processors further execute instructions to determine that the overlap between neighboring windows of the input data at the first size 2×2 max pooling stage is equal to zero and the window size is an odd value, and based thereon add a padding element to each window sized segment of the input data at the first size 2×2 max pooling stage, and adjust the window size and the size of the input data at the first size 2×2 max pooling stage.

Optionally, in any of the preceding aspects, the one or more processors further execute instructions to increment the window size, and adjust the size of the input data at the first size 2×2 max pooling stage in accordance with expression size=size+(size/the window size).

Optionally, in any of the preceding aspects, the one or more processors further execute instructions to adjust the window size in accordance with expression window size=(window size−2)/stride S+1, adjust the size of the input data at the first size 2×2 max pooling stage in accordance with expression size=(size−2)/stride S+1, and adjust the overlap in accordance with expression overlap=(overlap−2)/2+1.

Optionally, in any of the preceding aspects, the one or more processors further execute instructions to repeat the determining the stride S, the applying, the saving, and the adjusting until a size of input data at remaining size 2×2 max pooling stages is equal to the final size.

Practice of the foregoing aspects enables a reduction in resource requirements in a neural network by implementing a size K×K max pooling with stride S layer as a cascade of size 2×2 max pooling layers. The use of small size max pooling layers reduces the computational and memory resources required when compared with large size max pooling layers.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of an example CNN;

FIG. 2 illustrates a diagram highlighting an example max pooling operation performed by a pooling layer of a CNN;

FIG. 3 illustrates an example arrangement of image data and an ordering of data elements at a max pooling layer;

FIG. 4 illustrates an example data buffer supporting N×N input data with a size K×K max pooling kernel;

FIG. 5 illustrates an example reduction tree of comparators;

FIG. 6 illustrates a diagram demonstrating a determining of a maximum of a size 3×3 window of input data using a size 2×2 max pooling kernel;

FIG. 7 illustrates the partitioning of a size K×K max pooling with stride S kernel into a cascade of K−1 size 2×2 max pooling stages;

FIG. 8 illustrates a diagram of the correspondence between two-dimensional max pooling and one-dimensional max pooling according to example embodiments described herein;

FIGS. 9A and 9B illustrate example size of the input at a max pooling stage and window size according to example embodiments presented herein;

FIGS. 10A and 10B illustrate example size of the input of a max pooling stage, window size, and overlap values of a max pooling stage according to example embodiments presented herein;

FIG. 11 illustrates a flow diagram of example operations occurring in a device performing dynamic max pooling according to example embodiments presented herein;

FIG. 12 illustrates a diagram of the application of a size 5 max pooling with stride 2 kernel realized with dynamic max pooling to a size 9 input data according to example embodiments presented herein;

FIG. 13 illustrates a diagram of the application of a size 6 max pooling with stride 6 kernel realized with dynamic max pooling to a size 12 input data according to example embodiments presented herein;

FIG. 14 illustrates a hardware implementation of a size 2×2 max pooling stage according to example embodiments presented herein; and

FIG. 15 is a block diagram of a computing system that may be used for implementing the devices and methods disclosed herein.

### DETAILED DESCRIPTION OF ILLUSTRATIVE EMBODIMENTS

The making and using of the disclosed embodiments are discussed in detail below. It should be appreciated, however, that the present disclosure provides many applicable inventive concepts that can be embodied in a wide variety of specific contexts. The specific embodiments discussed are merely illustrative of specific ways to make and use the embodiments, and do not limit the scope of the disclosure.

As discussed previously, convolutional neural networks (CNNs) are a sub-class of neural networks (NNs) that have a distinct logical representation of computational layers optimized for tasks such as image classification. A CNN may learn to identify features of an image through training where the CNN is provided a controlled reference input dataset that is known to include data representative of some images containing visual objects of interest. Once training is complete, the CNN begins an inference phase, where the CNN may be deployed to detect visual objects of interest from images input to the trained CNN. Overall, CNNs may require significant compute and memory resources, especially during training.

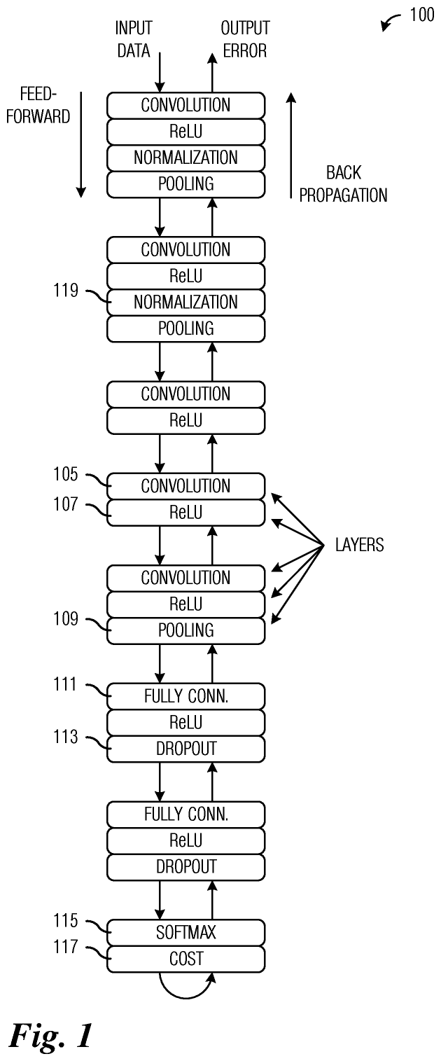

FIG. 1 illustrates a diagram of an example CNN 100. Each CNN comprises several layers that are combined together and represented logically as a network of compute elements. As shown in FIG. 1, CNN 100 includes layers, including a convolution layer (such as convolution layer 105), a rectified linear unit (ReLU) layer (such as ReLU layer 107) that applies an activation function to the data, a pooling layer (such as pooling layer 109) that downsamples the data, a fully connected layer (such as fully connected layer 111), a dropout layer (such as dropout layer 113) that activates or deactivates neurons, a softmax layer (such as softmax layer 115) that implements a loss function, a cost layer (such as cost layer 117) that implements a cost function for the neurons, and a normalization layer (such as normalization layer 119) that adjusts neuron responses. CNN 100, and the arrangement of the layers and the flow of the data therein, is presented as an example for discussion purposes. Therefore, CNN 100 is not intended to be limiting to the scope or the spirit of the example embodiments.

The pooling layer is a data processing layer of a CNN and may appear multiple times in the CNN. The pooling layer downsamples or spatially shrinks data at its input, and reduces the data volume at its output. The pooling layer reduces memory and compute requirements of subsequent layers. The pooling layer partitions its input data into windows and determines a single value from the values in each window. Different schemes may be implemented at a pooling layer, including:

Max pooling—the maximum value from the values in a window is selected as the single value;

Average pooling—an average of the values in a window is determined as the single value; and

Weighted average pooling—a weighted average of the values in a window is determined as the single value.

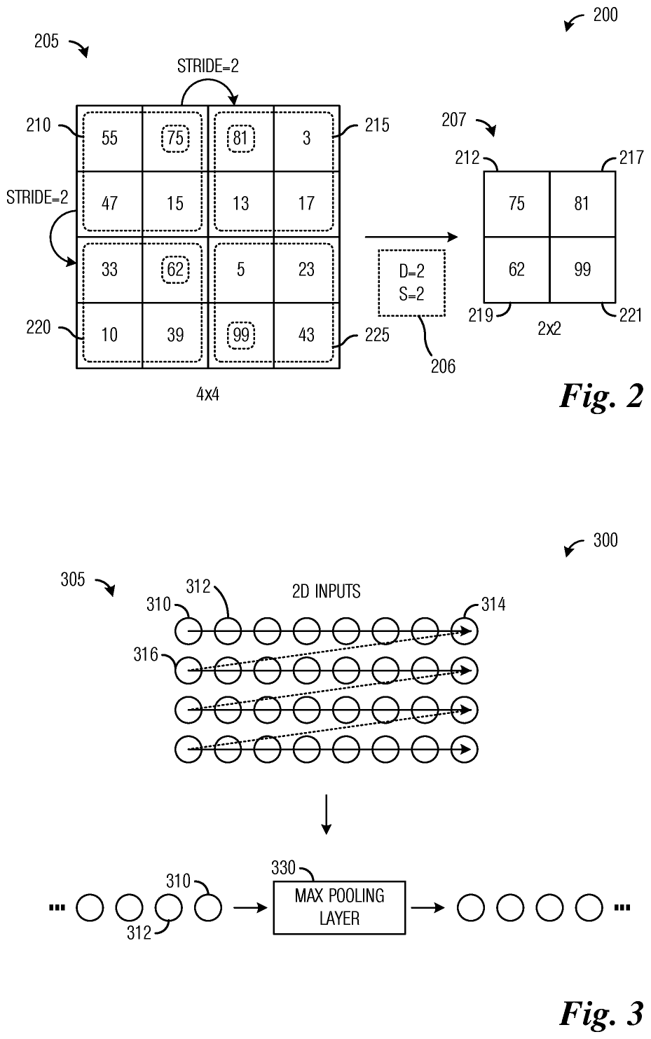

FIG. 2 illustrates a diagram 200 highlighting an example max pooling operation performed by a pooling layer of a CNN. As shown in FIG. 2, a 4×4 matrix 205 is input to a size 2×2 max pooling with stride 2 layer 206, which is hereinafter referred to as max pooling layer 206. The size of a max pooling layer specifies the size of the windows of the input data (e.g., the 4×4 matrix 205), and the stride specifies an offset position where a next window of the input data begins. Therefore, a size 2×2 max pooling layer operates on a size 2×2 window of input data and produces a single output value per size 2×2 window of input data. Output of max pooling layer 206 is a size 2×2 matrix 207. Because the size of max pooling layer 206 is 2, each individual window of input data processed by max pooling layer 206 is a 2×2 sub-matrix. In the example shown in FIG. 2, the input data (e.g., the 4×4 matrix 205) is partitioned into windows 210, 215, 220, 225, where each window is a 2×2 sub-matrix. As discussed previously, a max pooling layer will determine the maximum value from the values of each window and output the single value. As an example, for window 210, the maximum value is 75, for window 215, the maximum value is 81, for window 220, the maximum value is 62, and for window 225, the maximum value is 99. Matrix 207 contains the single value output for each of the individual windows. As an example, element 212 holds value 75, which corresponds to the maximum value for window 210, element 217 holds value 81, which corresponds to the maximum value for window 215, element 219 holds value 62, which corresponds to the maximum value for window 220, and element 221 holds value 99, which corresponds to the maximum value for window 225

The partitioning of the input data may be described as follows:

Start from the top left corner of the input data matrix and form a sub-matrix of the same size as the size of the max pooling stage, which is commonly referred to as a pooling kernel. Find the maximum value in the sub-matrix. The maximum value is the single value representing the particular sub-matrix.

Move to the right by the stride amount and form another sub-matrix of the same size as the pooling kernel. Find the maximum value in the sub-matrix. The maximum value is the single value representing the particular sub-matrix.

Repeat until the end of the input data in the horizontal direction is reached.

Move back to the left side of the input data matrix. Move down by the stride amount and form another sub-matrix with the same size as the pooling kernel. Find the maximum value in the sub-matrix. The maximum value is the single value representing the particular sub-matrix.

Repeat moving to the right and down until all data from the input data matrix is covered.

In hardware device architectures, in many situations it is optimal to implement a streaming architecture. A streaming architecture refers to a data execution model where compute operations can be fully pipelined so that in optimal conditions for every clock cycle of execution, a result is produced. In general, this is optimal for systems in which an input stream of data can be provided to the hardware device to sustain the pipelined execution. In the case of image processing, graphic processors implement architectures to concurrently buffer input images while executing compute units.

FIG. 3 illustrates an example arrangement 300 of image data and an ordering of data elements at a max pooling layer. When processing image data in a CNN, the order of the data elements as they arrive at a max pooling layer is also a concern. Image data is typically organized into two-dimensional arrays of pixels, where each pixel is associated with a Cartesian coordinate of where the image appears on a display. As shown in FIG. 3, image data is arranged in a two-dimensional array 305. Furthermore, when performing max pooling (or other forms of image processing) image data is provided in raster-order, where the first data element to arrive is the element from the first row and first column of the two-dimensional array, followed by data elements to its right and then starting again at the left most data element of the second row, etc. As an example, a first data element 310 of two-dimensional array 305 is the first to arrive at a max pooling layer, followed by a second data element 312, and so on. A last data element 314 of the first row is followed by the first data element 316 of the second row, etc.

In a streaming architecture implementation of a max pooling layer, compute operations should be fully pipelined in order to achieve maximum compute performance. If the image data arrives in raster order, then some execution clock cycles are spent loading data elements into memory until a full max pooling window is available, which negatively impacts performance and increases memory requirements. This is a problem to be addressed in the streaming architecture of the max pooling layer.

A typical streaming architecture implementation of a max pooling layer includes:

A buffer to store data for overlapping windows provided to the max pooling layer; and

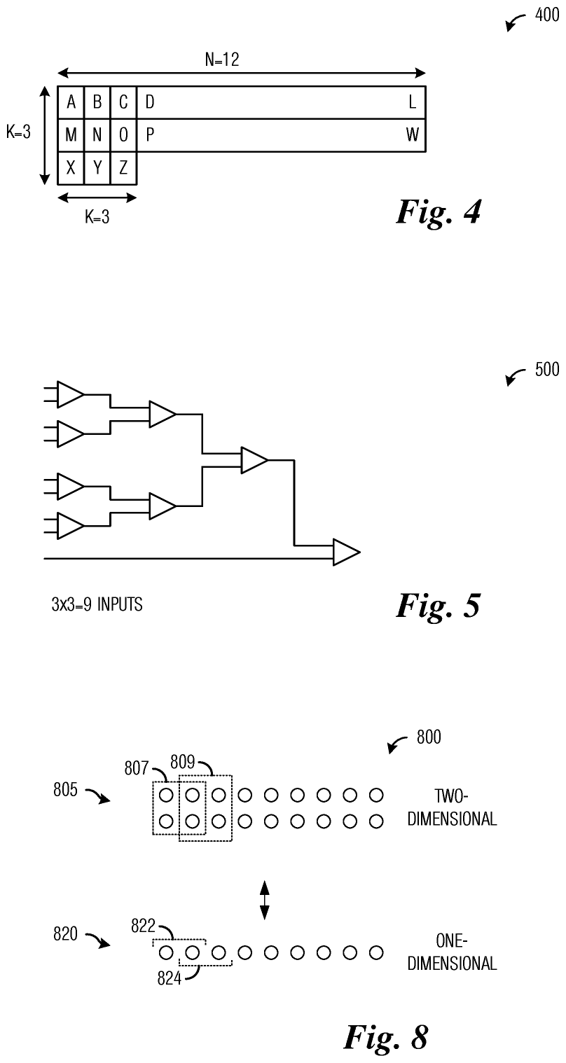

A plurality of comparators to compute the maximum value. FIG. 4 illustrates an example data buffer 400 supporting N×N input data with a size K×K max pooling kernel. For N×N input data with a size K×K max pooling kernel, a minimum size of a data buffer for streaming input data arriving in raster-scan order is expressible as:

Buffer_size=N(K−1)+K.

As shown in FIG. 4, data buffer 400 supports 12×12 input data with a size 3×3 max pooling kernel.

In order to support pipelined computation of the maximum value of an individual window, a reduction tree of comparators may be used. FIG. 5 illustrates an example reduction tree of comparators 500. Reduction tree of comparators 500 comprises a plurality of two-input comparators. A number of two-input comparators of a reduction tree of comparators supporting the computation of the maximum value of a window of input data with size K×K is expressible as:

Comparators_required=K*K−1.

As shown in FIG. 5, reduction tree of comparators 500 comprises 8 two-input comparators and supports the computation of the maximum value of a window of input data with size 3×3.

As shown above, the amount of buffer storage and the number of comparators grow as a function of:

Size of the max pooling kernel. The buffer storage and number of comparators grow in proportion to the size of the max pooling kernel for a fully parallel max pooling implementation. The buffer storage and number of comparators growth is compounded if the input data is multi-channeled. As an example, a typical image file has multiple channels for different colors (such as Red-Green-Blue), and max pooling is to be performed on each channel.

Number of max pooling layers in a particular CNN implementation. A CNN may have multiple max pooling layers.

As an example of the buffer storage and comparator needs of a streaming architecture implementation of a CNN, an example CNN with three max pooling layers is considered. The example CNN includes a first max pooling layer that supports size 3×3 max pooling with stride 2 on 96 channels, a second max pooling layer that supports size 3×3 max pooling with stride 2 on 256 channels, and a third max pooling layer that supports size 3×3 max pooling with stride 2 on 256 channels. In order to achieve streaming performance, at total of 96+256+256=608 instances of max pooling logic is needed to implement the example CNN directly in fully pipelined hardware.

In addition to the substantial hardware requirements, an attempt to map the computations of the example CNN onto smaller footprint devices, such as mobile handsets, user equipments (UEs), digital cameras, etc., would require more resources than typically available on these smaller footprint devices.

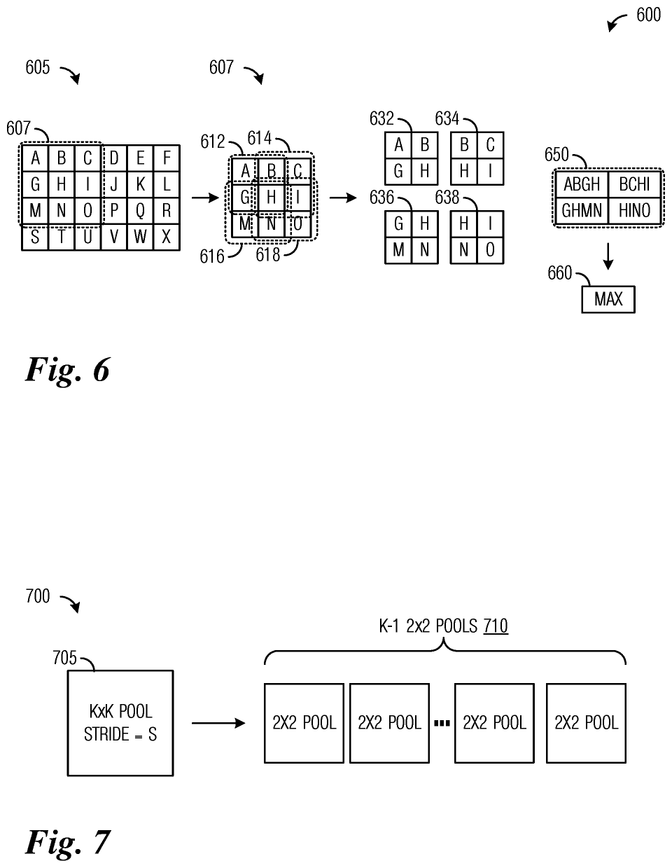

It is possible to determine a maximum of a large window of input data using a max pooling kernel with a size that is smaller than the size of the large window of input data. FIG. 6 illustrates a diagram 600 demonstrating a determining of a maximum of a size 3×3 window of input data using a size 2×2 max pooling kernel. As shown in FIG. 6, input data 605 is a size 6×4 matrix of data values and it is desired to determine a maximum value in a size 3×3 window 607 of input data 605. As an example, the maximum value of input data 605 may be determined by determine the maximum value in individual 3×3 sized windows of input data 605 spanning the entirety of input data 605.

In order to determine the maximum value of size 3×3 window 607 using a size 2×2 max pooling kernel, size 3×3 window 607 is partitioned into size 2×2 windows 612, 614, 616, and 618. There is some overlap in the size 2×2 windows that is due to the size difference between size 3×3 window 607 and the size 2×2 max pooling kernel. Size 2×2 matrices 632, 634, 636, and 638 display the input data in size 2×2 windows 612, 614, 616, and 618. A maximum value of each size 2×2 window 612, 614, 616, and 618 is determined using the size 2×2 max pooling kernel. A size 2×2 window 650 displays the output of the size 2×2 max pooling kernel after the size 2×2 max pooling kernel is applied to size 2×2 windows 612, 614, 616, and 618. Size 2×2 window 650 is then provided to the size 2×2 max pooling kernel to determine a maximum value 660 of size 2×2 window 650, which is also the maximum value of size 3×3 window 607.

In co-assigned patent application entitled “System and Method for Cascaded Max Pooling in Neural Networks”, U.S. application Ser. No. 16/131,780, attorney docket number HW 85789681USO1, filed Sep. 14, 2018, which is hereby incorporated herein by reference, it is shown that any size K×K max pooling with stride S kernel is realizable as a cascade of size 2×2 max pooling stages. The output produced by the first max pooling stage (and intermediate max pooling stages) in the cascade of size 2×2 max pooling stages becomes input for next max pooling stage, with exception of the last max pooling stage in the cascade of size 2×2 max pooling stages. The output of the last max pooling stage is the output of the size K×K max pooling with stride S kernel. The size K×K max pooling with stride S kernel is realizable as a cascade of K−2 size 2×2 max pooling with stride 1 stages and one size 2×2 max pooling with stride S stage. Each stage of the cascade (except for the last stage of the cascade) applies max pooling operations to the entirety of its input, with the output of one stage becoming the input of a subsequent stage. The last stage of the cascade applies the max pooling operations to the entirety of its input, with the output being the output of the size K×K max pooling with stride S kernel.

FIG. 7 illustrates the partitioning 800 of a size K×K max pooling with stride S kernel into a cascade of K−1 size 2×2 max pooling stages. As shown in FIG. 7, a size K×K max pooling with stride S kernel 705 is partitioned into a cascade of K−1 size 2×2 max pooling stages 710. The size 2×2 max pooling stages of cascade of K−1 size 2×2 max pooling stages 710 are arranged in a linear sequence, with the output of one stage being the input to the next stage. Cascade of K−1 size 2×2 max pooling stages 710 comprises K−2 size 2×2 max pooling with stride 1 stages 715 and one size 2×2 max pooling with stride S stage 720.

Cascaded max pooling achieves the same result of a size K×K max pooling with stride S kernel by applying a cascade of size 2×2 max pooling stages to the input data. During this process, output of one size 2×2 max pooling stage becomes the input of the subsequent size 2×2 max pooling stage. It is important to ensure that the values in different size K×K windows do not get mixed with each other at any stage of the cascaded size 2×2 max pooling stages. Otherwise it is possible to take the maximum of some values which would not have been compared in the first place had the original size K×K max pooling with stride S kernel been applied. In the examples that follow, values in each window of input data of the cascaded size 2×2 max pooling stages are analyzed to ensure that right comparisons are made. To simplify the figures, examples that follow are given with one-dimensional max pooling instead of two-dimensional max pooling. For the purpose of this discussion, one-dimensional max pooling and two-dimensional max pooling produce similar results.

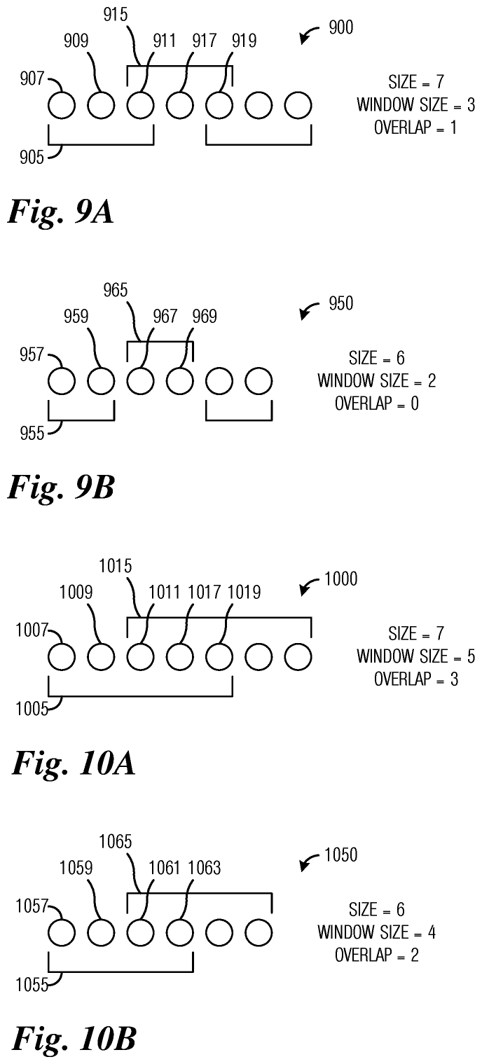

FIG. 8 illustrates a diagram 800 of the correspondence between two-dimensional max pooling and one-dimensional max pooling. As shown in FIG. 8 (and also in FIGS. 9A, 9B, 10A, 10B, 12 and 13), the windows of values in one-dimensional max pooling indicate the values for which the maximum should be calculated. These windows of values in one dimension correspond to the windows of values in two dimensions. A first sequence of data values 805 represents two-dimensional data, such as image data. First sequence of data values 805 comprises a 2×9 array, but the example embodiments presented herein are operable with arrays of other dimensions. A size 2×2 max pooling with stride 1 kernel is applied to first sequence of data values 805. In a first application of the size 2×2 max pooling with stride 1 kernel, data values in window 807 are processed, and in a second application of the size 2×2 max pooling with stride 1 kernel, data values in window 809 are processed, and so on. A second sequence of data values 820 represents one-dimensional data, such as image data. Second sequence of data values 820 comprises a 1×9 array, but the example embodiments presented herein are operable with arrays of other dimensions. A size 2 max pooling with stride 1 kernel is applied to second sequence of data values 820. In a first application of the size 2 max pooling with stride 1 kernel, data values in window 822 are processed, and in a second application of the size 3 max pooling with stride 1 kernel, data values in window 824 are processed.

The application of the max pooling kernel shown in FIG. 8 occurs in the horizontal direction. However, the application of the max pooling kernel in the vertical direction is also similar. Therefore, it is possible to simplify the illustration of the application of the max pooling kernel by showing the process in one dimension.

According to an example embodiment, any size K×K max pooling with stride S kernel is partitioned into a cascade of size 2×2 max pooling stages. The size 2×2 max pooling stages are arranged into a linear sequence of size 2×2 max pooling stages, with the output produced by the first max pooling stage (and intermediate max pooling stages) in the cascade of size 2×2 max pooling stages becomes input for next max pooling stage, with exception of the last max pooling stage in the cascade of size 2×2 max pooling stages. The output of the last max pooling stage is the output of the size K×K max pooling with stride S kernel.

According to an example embodiment, a size K×K max pooling with stride S kernel is implemented using a cascade of size 2×2 max pooling stages with the stride of each of the size 2×2 max pooling stages being dynamically determined. In an embodiment, the stride of each of the size 2×2 max pooling stages is determined dynamically, based upon pooling parameters of the size 2×2 max pooling stage. Examples of pooling parameters that have an impact on the stride of the size 2×2 max pooling stages include: a size of input at the size 2×2 max pooling stage, a window size of the size 2×2 max pooling stage, an overlap between neighboring windows of the size 2×2 max pooling stage, and so on. As an example, the stride of any of the size 2×2 max pooling stages is either 1 or 2, determined in accordance with the pooling parameters of the size 2×2 max pooling stage.

According to an example embodiment, a size K×K max pooling with stride S kernel is implemented using a cascade of size 2×2 max pooling stages with the number of size 2×2 max pooling stages being dynamically determined. As an example, there are J size 2×2 max pooling stages in the cascade of size 2×2 max pooling stages, where the output size of the J-th size 2×2 max pooling stage is equal to a final output size. The final output size is determined in accordance with initial pooling parameters, such as the initial size of the input N at the 2×2 max pooling stage, the max pooling kernel size K×K, and stride S.

As discussed previously, pooling parameters include a size of the input at a max pooling stage, window size at a max pooling stage, overlap between neighboring windows at a max pooling stage, and so on. In a situation where the original size of the input at a max pooling state is N×N, max pooling kernel size is K×K, and stride is S, the pooling parameters may be defined as follows:

Size (of a stage): The total size of the input in either dimension. Initially, the size is equal to the original size of the input. The size generally shrinks after each max pooling stage, with the size ending up being equal to a final output size that would be obtained by the original max pooling kernel.

Window size (of a stage): The number of data values in a window at a particular max pooling stage. The window size is initially equal to the original max pooling kernel size. The window size shrinks after each max pooling stage, with the window size ending up being equal to one.

Overlap (of a stage): The number of data values that two neighboring windows have in common. The overlap reduces after each max pooling stage, with the overlap ending up being equal to zero.

FIGS. 9A and 9B illustrate example size of the input at a max pooling stage and window size. As shown in FIG. 9A, sequence of data values 900 includes seven data values, such as data values 907, 909, 911, 917, and 919. Hence, size (denoted as SIZE) is equal to seven. The data values are partitioned into groups of three data values each, such as window groups 905 and 915. Therefore, the window size (denoted as WINDOW SIZE) is equal to three. As shown in FIG. 9B, sequence of data values 950 includes six data values, such as data values 957, 959, 967, and 969. Hence, size is equal to six. The data values are partitioned into groups of two data values each, such as window groups 955 and 965. Therefore, the window size is equal to two.

FIGS. 10A and 10B illustrate example size of the input of a max pooling stage, window size, and overlap values of a max pooling stage. As shown in FIG. 10A, sequence of data values 100 includes seven data values, such as data values 1007, 1009, 1011, 1017, and 1019. Hence, size is equal to seven. The data values are partitioned into groups of five data values each, such as window groups 1005 and 1015. Therefore, the window size is equal to five. Furthermore, each window shares three data values, thus the overlap (denoted OVERLAP) is equal to three. As shown in FIG. 10B, sequence of data values 1050 includes six data values, such as data values 1057, 1059, 1061, and 1063. Hence, size is equal to six. The data values are partitioned into groups of four data values each, such as window groups 1055 and 1065. Therefore, the window size is equal to four. The two window groups 1055 and 1065 share two data values (thus, overlap is equal to two).

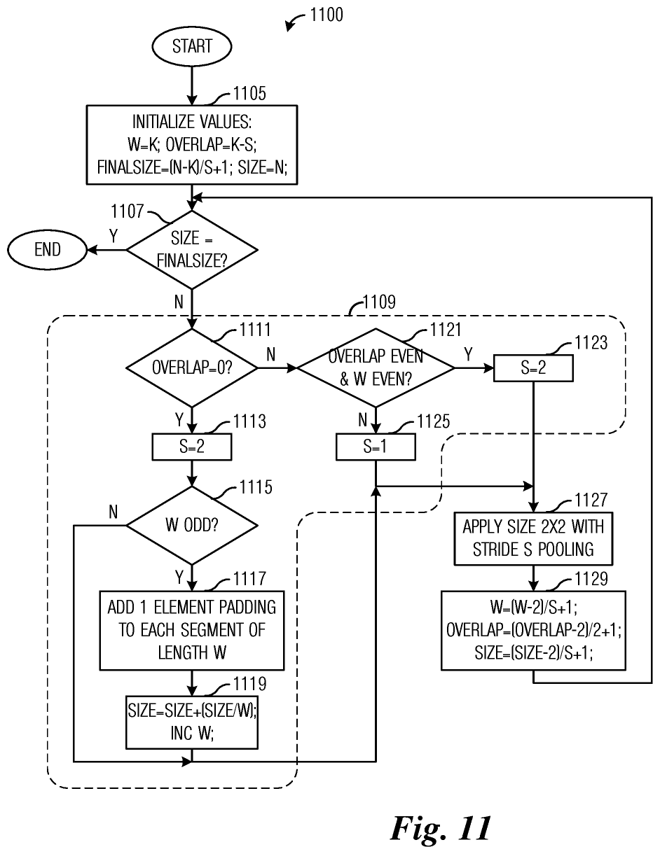

FIG. 11 illustrates a flow diagram of example operations 1100 occurring in a device performing dynamic max pooling. Operations 1100 may be indicative of operations occurring in a device as the device performs dynamic max pooling to downsample input data. As discussed previously, dynamic max pooling realizes a size K×K max pooling with stride S kernel with an input of size N as a cascade of size 2×2 max pooling stages, where the stride of each size 2×2 max pooling stage is dynamically determined. Furthermore, the total number of size 2×2 max pooling stages is also dynamically determined.

Operations 1100 begin with the device initializing values (block 1105). In a situation where it is given that the input data is an N×N matrix and that the max pooling kernel to realize is a size K×K max pooling with stride S kernel, the following values are set initially:

Input size (SIZE): Initialize SIZE to input size,

SIZE=N;

Window size (W): Initialize W to kernel size,

W=kernel size=K;

Overlap (OVERLAP): Initialize OVERLAP to difference of kernel size and stride,

OVERLAP=kernel size−stride=K−S;

Final size (FINALSIZE): FINALSIZE is the size of the output if the original size K×K max pooling with stride S kernel is applied to the input data. FINALSIZE is the stop condition, and the operations stop whenever SIZE is equal to FINALSIZE,

FINALSIZE=(input size−kernel size)/stride+1=(N−K)/S+1.

The device performs a check to determine if the stop condition is met (block 1107). As discussed previously, the stop condition is when the size of the input to a size 2×2 max pooling stage is equal to the final size (e.g., SIZE is equal to FINALSIZE). If the stop condition is met, operations 1100 ends and the input is the output of the dynamic max pooling realization of the size K×K max pooling with stride S kernel.

If the stop condition is not met, the device determines the stride to be used for the size 2×2 max pooling stage (blocks 1109). The determination of the stride of the size 2×2 max pooling stage is in accordance with the pooling parameters of the size 2×2 max pooling stage. Examples of the pooling parameters include the input size of the size 2×2 max pooling stage, the window size of the size 2×2 max pooling stage, and the overlap of the size 2×2 max pooling stage.

An example determination of the stride of the size 2×2 max pooling stage includes the device performing a check to determine if the overlap of the size 2×2 max pooling stage is equal to zero (block 1111). If the overlap is equal to zero, the stride S is set to two (block 1113). The device also performs a check to determine if the window size W is odd (block 1115). If the window size W is odd, the device adds a padding element to each grouping of window size W data values (block 1117). In other words, the device adds the padding element to make the number of data values in each window even, enabling the max pooling operation to be performed on a fixed hardware implementation of a size 2×2 max pooling kernel. The padding element may be a zero value to have no impact on the max pooling operation, for example. The device also updates the window size W and the input size SIZE values (block 1119). As an example, the window size W is incremented by one (due to the addition of the one padding element per group of W data values), while the input size SIZE is updated using expression:

SIZE=SIZE+(SIZE/W).

If the overlap of the size 2×2 max pooling stage is not equal to zero (block 1111), the device performs a check to determine if both the overlap of the size 2×2 max pooling stage is even and the window size W is even (block 1121). If the device determines that both the overlap of the size 2×2 max pooling stage is even and the window size W is even, then the device sets the stride S to two (block 1123). In all other cases, the device sets the stride S to one (block 1125).

The device applies the size 2×2 max pooling with stride S kernel to the input of the size 2×2 max pooling stage (block 1127). The device adjusts the window size W, the overlap OVERLAP, and the input size SIZE values (block 1129). Examples of the adjusting of the values include:

W=(W−2)/S+1;

OVERLAP=(OVERLAP−2)/S+1;

SIZE=(SIZE−2)/S+1.

The device returns to block 1107 to repeat the determination if the stop condition is been met.

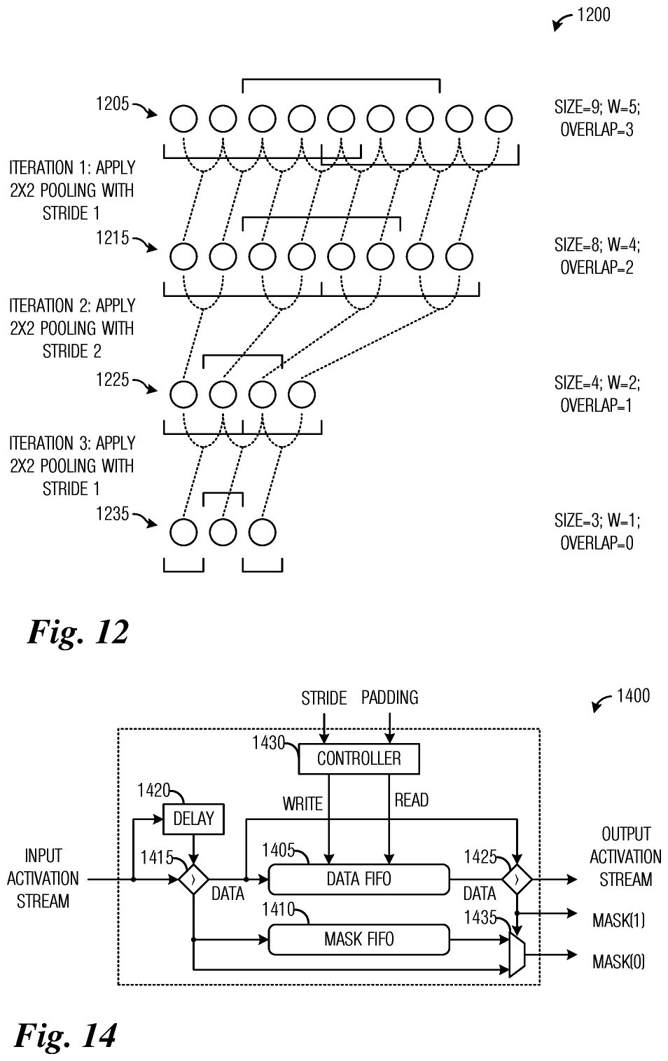

FIG. 12 illustrates a diagram 1200 of the application of a size 5 max pooling with stride 2 kernel realized with dynamic max pooling to a size 9 input data. The max pooling shown in FIG. 12 is one-dimensional max pooling and is presented as an analog to two-dimensional max pooling in order to simplify the figure. The example embodiments presented herein are operable with one-dimensional or two-dimensional max pooling. The presentation of one-dimensional max pooling is not intended to be limiting to either the scope or spirit of the example embodiments. As described previously, the size 5 max pooling with stride 2 kernel is realized as a cascade of size 2 max pooling stages with dynamically configured stride. Following operations 1100 of FIG. 11, for example, the initial values as determined in block 1105 are SIZE=9, W=5, OVERLAP=3, and FINALSIZE=3. Because, SIZE is not equal to FINALSIZE, a first size 2 max pooling stage with stride S=1 is performed (because OVERLAP is not equal to zero and is not even). A first sequence of 9 data values 1205 illustrate the application of the size 2 max pooling with stride 1 operation. Adjusted values as determined in block 1129 are SIZE=8, W=4, and OVERLAP=2. Because SIZE is not equal to FINALSIZE, a second size 2 max pooling stage with stride S=2 is performed (because OVERLAP is not equal to zero, but OVERLAP is even and W is even). A second sequence of 8 data values 1215 illustrate the application of the size 2 max pooling with stride 2 operation. Adjusted values as determined in block 1129 are SIZE=4, W=2, and OVERLAP=1.

Because SIZE is not equal to FINALSIZE, a third size 2 max pooling stage with stride S=1 is performed (because OVERLAP is not equal to zero and is not even). A third sequence of 4 data values 1225 illustrate the application of the size 2 max pooling with stride 1 operation. Adjusted values as determined in block 1129 are SIZE=3, W=1, and OVERLAP=1. Because SIZE is equal to FINALSIZE, the stop condition (block 1107 of FIG. 11, for example) is met and the realization of the size 5 max pooling with stride 2 kernel using dynamic max pooling is complete.

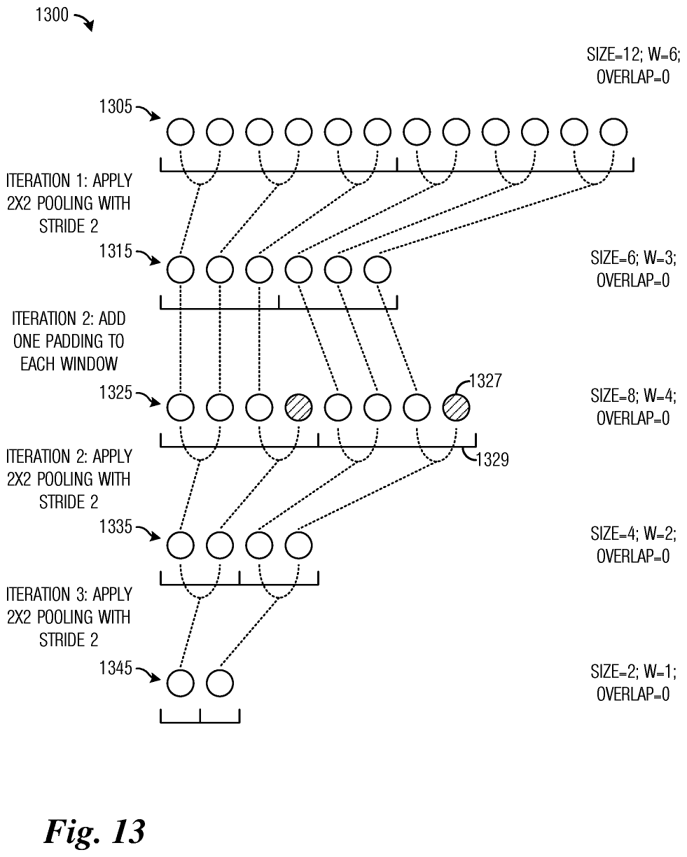

FIG. 13 illustrates a diagram 1300 of the application of a size 6 max pooling with stride 6 kernel realized with dynamic max pooling to a size 12 input data. The max pooling shown in FIG. 13 is one-dimensional max pooling and is presented as an analog to two-dimensional max pooling in order to simplify the figure. The example embodiments presented herein are operable with one-dimensional or two-dimensional max pooling. The presentation of one-dimensional max pooling is not intended to be limiting to either the scope or spirit of the example embodiments. As described previously, the size 6 max pooling with stride 6 kernel is realized as a cascade of size 2 max pooling stages with dynamically configured stride. Following operations 1100 of FIG. 11, for example, the initial values as determined in block 1105 are SIZE=12, W=6, OVERLAP=0, and FINALSIZE=2. Because SIZE is not equal to FINALSIZE, a first size 2 max pooling stage with stride S=2 is performed (because OVERLAP is equal to zero and W is even). A first sequence of 12 data values 1305 illustrates the application of the size 2 max pooling with stride 2 operation. Adjusted values as determined in block 1129 are SIZE=6, W=3, and OVERLAP=0.

A second sequence of 6 data values 1315 illustrates the output of the first size 2 max pooling stage. Because SIZE is not equal to FINALSIZE, a second size 2 max pooling stage with stride S=2 is performed (because OVERLAP is equal to zero and W is odd). However, because W is odd, a padding element is added to each grouping of W data values. A third sequence of 8 data values 1325 illustrates the output of the first size 2 max pooling stage after padding elements have been added. As an example, padding element 1327 is added to grouping 1329. Third sequence of 8 data values 1325 illustrates the application of the second size 2 max pooling stage with stride 2. Adjusted values as determined in block 1129 are SIZE=4, W=2, and OVERLAP=0.

A fourth sequence of 4 data values 1335 illustrates the output of the second size 2 max pooling stage. Because SIZE is not equal to FINALSIZE, a third size 2 max pooling stage with stride S=2 is performed (because OVERLAP is equal to zero and W is even). Fourth sequence of 4 data values 1335 illustrates the application of the size 2 max pooling with stride 2 operation. Adjusted values as determined in block 1129 are SIZE=2, W=1, and OVERLAP=0. A fifth sequence of 2 data values 1345 illustrates the output of the third size 2 max pooling stage. Because SIZE is equal to FINALSIZE, the stop condition (block 1107 of FIG. 11, for example) is met and the realization of the size 6 max pooling with stride 6 kernel using dynamic max pooling is complete.

FIG. 14 illustrates a hardware implementation of a size 2×2 max pooling stage 1400. Size 2×2 max pooling stage 1400 is capable of implementing a size 2×2 max pooling stage with any stride, and may be used in the realization of a size K×K max pooling with stride S kernel as a cascade of size 2×2 max pooling stages with dynamically determined stride S as discussed previously. Size 2×2 max pooling stage 1400 allows for the sequential execution (with fully pipelined operation) of each pooling layer of a CNN.

Size 2×2 max pooling stage 1400 includes a data first in first out (FIFO) buffer 1405 that stores the partial results of the size K×K max pooling with stride S kernel, as well as a mask FIFO buffer 1410 that removes temporary junk values produced when the size 2×2 max pooling stage 1400 processes data values that span adjacent windows. According to an embodiment, a size of data FIFO buffer 1405 is at least equal to the size of the intermediate output at each size 2×2 max pooling stage.

Size 2×2 max pooling stage 1400 also includes a first comparator 1415 having a first input coupled to a data input and a second input coupled to a delayed version of the data input, wherein the delayed version of the data input is provided by a delay unit 1420. First comparator 1415 is configured to compare a data input value with a delayed data input value and output the larger of the two. Size 2×2 max pooling stage 1400 also includes a second comparator 1425 having a first input coupled to an output of data FIFO buffer 1405 and a second input coupled to an output of first comparator 1415. Second comparator 1425 is configured to compare a data value from data FIFO buffer 1405 with an output of first comparator 1415 and output the larger of the two. The output of second comparator 1425 is either the output of an intermediate size 2×2 max pooling stage or the output of the size K×K max pooling with stride S kernel.

Size 2×2 max pooling stage 1400 also includes a controller 1430 coupled to data FIFO buffer 1405, and a stride value input. Controller 1415 is configured to control data FIFO buffer 1405 to store or output data values in accordance with a stride value determined in accordance with an initial stride value on the stride value input. The stride value may be determined by controller 1430 in accordance with the pooling parameter of the size 2×2 max pooling stage being implemented. Examples of the pooling parameters include the size of the input of the size 2×2 max pooling stage, the window size of the size 2×2 max pooling stage, and the overlap of the size 2×2 max pooling stage. Depending on the stride value, controller 1415 uses a write control line and a read control line to have data FIFO buffer 1405 store or output data values from first comparator 1415. Alternatively, a processor coupled to size 2×2 max pooling stage 1400 may determine the stride value (based on the pooling parameters, for example) and provide the stride value to controller 1415. The processor may be a part of a graphics processing unit that includes size 2×2 max pooling stage 1400 or the processor may be a part of a computing system that includes the graphics processing unit that includes size 2×2 max pooling stage 1400. The processor may also control a padding input that results in size 2×2 max pooling stage 1400 adding padding elements to the input data.

Size 2×2 max pooling stage 1400 also includes a multiplexor 1435 having a first input coupled to an output of mask FIFO 1410, a second input coupled to the output of first comparator 1415, and a control input coupled to the output of second comparator 1425. Depending on the control input, multiplexor 1435 outputs junk values or the output of first comparator 1415.

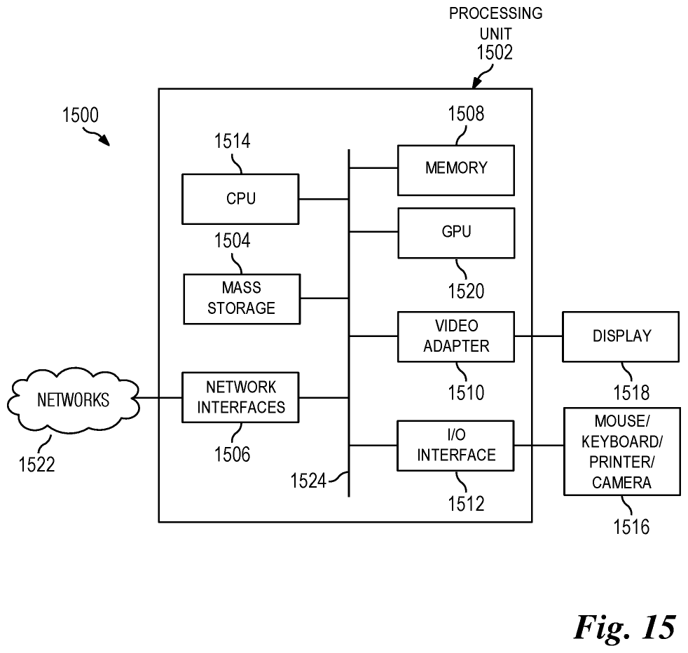

FIG. 15 is a block diagram of a computing system 1500 that may be used for implementing the devices and methods disclosed herein. For example, the computing system can be any entity of hand-held computing device, wireless handset, touchpad tablet, touchpad PC, digital camera, video camera, surveillance camera, and so on. Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1500 includes a central processing unit (CPU) 1514, memory 1508, and may further include a mass storage device 1504, a video adapter 1510, an I/O interface 1512, and a graphics processing unit (GPU) 1520 connected to a bus 1524.

The bus 1524 may be one or more of any type of several bus architectures including a memory bus or memory controller, a peripheral bus, or a video bus. The CPU 1514 may comprise any type of electronic data processor. The memory 1508 may comprise any type of non-transitory system memory such as static random access memory (SRAM), dynamic random access memory (DRAM), synchronous DRAM (SDRAM), read-only memory (ROM), or a combination thereof. In an embodiment, the memory 1508 may include ROM for use at boot-up, and DRAM for program and data storage for use while executing programs.

The mass storage 1504 may comprise any type of non-transitory storage device configured to store data, programs, and other information and to make the data, programs, and other information accessible via the bus 1524. The mass storage 1504 may comprise, for example, one or more of a solid state drive, hard disk drive, a magnetic disk drive, or an optical disk drive.

The video adapter 1510 and the I/O interface 1512 provide interfaces to couple external input and output devices to the processing unit 1502. As illustrated, examples of input and output devices include a display 1518 coupled to the video adapter 1510 and a mouse, keyboard, printer, or camera 1516 coupled to the I/O interface 1512. Other devices may be coupled to the processing unit 1502, and additional or fewer interface cards may be utilized. For example, a serial interface such as Universal Serial Bus (USB) (not shown) may be used to provide an interface for an external device.

The GPU 1520 processes graphical data, such as images captured by the mouse, keyboard, printer, or camera 1516. The GPU 1520 makes use of computation techniques to process large amounts of data, to perform image detection, speech recognition, and so on. As an example, the GPU 1520 includes an implementation of a neural network, such as a CNN. The CNN includes a variety of processing layers, including one or more pooling layers to downsample the large amounts of data. The GPU 1520 also processes other types of data with efficient algorithms, to perform cryptocurrency mining, for example. The GPU 1520 can be the device that performs dynamic max pooling.

The computing system 1500 also includes one or more network interfaces 1506, which may comprise wired links, such as an Ethernet cable, or wireless links to access nodes or different networks. The network interfaces 1506 allow the computing system to communicate with other computing systems, such as servers, mobile devices, etc., via the networks. For example, the network interfaces 1506 may provide wireless communication via one or more transmitters/transmit antennas and one or more receivers/receive antennas. In an embodiment, the computing system 1500 is coupled to a local-area network 1522 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a buffering unit or module, a determining unit or module, an adjusting unit or module, a saving unit or module, an outputting unit or module, a setting unit or module, an adding unit or module, or an applying unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the spirit and scope of the disclosure as defined by the appended claims.

What is claimed is:

1. A computer-implemented method for performing size K×K max pooling with stride S at a max pooling layer of a convolutional neural network to downsample input data, the computer-implemented method comprising:
receiving, at the max pooling layer, input data;
buffering, at the max pooling layer, the input data;
applying, at the max pooling layer, a cascade of size 2×2 max pooling stages to the buffered input data to generate downsampled output data, wherein a stride value of each size 2×2 max pooling stage is determined dynamically in accordance with pooling parameters associated with the size 2×2 max pooling stage; and
outputting, by the max pooling layer, the downsampled output data to another layer of the convolution neural network for further processing.

2. The computer-implemented method of claim 1, wherein the pooling parameters associated with the size 2×2 max pooling stage comprises at least one of a size of input data at the size 2×2 max pooling stage, a window size of the size 2×2 max pooling stage, or an overlap between neighboring windows of the size 2×2 max pooling stage.

3. The computer-implemented method of claim 2, wherein the overlap between the neighboring windows of the size 2×2 max pooling stage is determined in accordance with the size of the input data at the size 2×2 max pooling stage, and the window size of the size 2×2 max pooling stage.

4. The computer-implemented method of claim 1, wherein applying the cascade of size 2×2 max pooling stages comprises:
determining, by the max pooling layer, a size of the buffered input data and a final size of the downsampled output;
determining, by the max pooling layer, an overlap between neighboring windows of input data of a first size 2×2 max pooling stage in the cascade of size 2×2 max pooling stages, and a window size of the input data of the first size 2×2 max pooling stage;
determining, by the max pooling layer, a stride S of the first size 2×2 max pooling stage in accordance with the overlap, and the window size;
applying, by the max pooling layer, the size 2×2 max pooling with the stride S kernel to the input data of the first size 2×2 max pooling stage to generate intermediate downsampled output data;
saving, by the max pooling layer, the intermediate downsampled output data; and
adjusting, by the max pooling layer, the size of input data at the first size 2×2 max pooling stage, the window size of the first size 2×2 max pooling stage, and the overlap between neighboring windows of the first size 2×2 max pooling stage.

5. The computer-implemented method of claim 4, wherein determining the stride S of the first size 2×2 max pooling stage comprises:
determining, by the max pooling layer, that the overlap between neighboring windows of the input data at the first size 2×2 max pooling stage is equal to zero, and based on the determination that the overlap between neighboring windows of the input data at the first size 2×2 max pooling stage is equal to zero, setting, by the max pooling layer, the stride S to two;
determining, by the max pooling layer, that the overlap between neighboring windows of the input data at the first size 2×2 max pooling stage is a first even value and the window size of the first size 2×2 max pooling stage is a second even value, and based on the determination that the overlap between neighboring windows of the input data at the first size 2×2 max pooling stage is a first even value and the window size of the first size 2×2 max pooling stage is a second even value, setting, by the max pooling layer, the stride S to two; and
setting, by the max pooling layer, the stride S to one for any other possible values of the overlap between neighboring windows of the input data at the first size 2×2 max pooling stage and the window size of the first size 2×2 max pooling stage.

6. The computer-implemented method of claim 5, further comprising:
determining that the overlap between neighboring windows of the input data at the first size 2×2 max pooling stage is equal to zero and the window size is an odd value, and based on the determination that the overlap between neighboring windows of the input data at the first size 2×2 max pooling stage is equal to zero and the window size is an odd value:
adding, by the max pooling layer, a padding element to each window sized segment of the input data at the first size 2×2 max pooling stage; and
adjusting, by the max pooling layer, the window size and the size of the input data at the first size 2×2 max pooling stage.

7. The computer-implemented method of claim 6, wherein adjusting the window size and the size of the input data at the first size 2×2 max pooling stage comprises:
incrementing, by the max pooling layer, the window size; and
adjusting, by the max pooling layer, the size of the input data at the first size 2×2 max pooling stage in accordance with expression
size=size+(size/the window size).

8. The computer-implemented method of claim 4, wherein adjusting the size of the input data at the first size 2×2 max pooling stage, the window size, and the overlap comprises:
adjusting, by the max pooling layer, the window size in accordance with expression
window size=(window size−2)/stride S+1;
adjusting, by the max pooling layer, the size of the input data at the first size 2×2 max pooling stage in accordance with expression
size=(size−2)/stride S+1; and
adjusting, by the max pooling layer, the overlap in accordance with expression
overlap=(overlap−2)/2+1.

9. The computer-implemented method of claim 4, further comprising repeating, by the max pooling layer, the determining the stride S, the applying, the saving, and the adjusting until a size of input data at remaining size 2×2 max pooling stages is equal to the final size.

10. A device for performing size K×K max pooling with stride S at a max pooling layer of a convolutional neural network to downsample input data, the device comprising:
a non-transitory memory storage comprising instructions; and
one or more processors in communication with the memory storage, wherein the one or more processors execute the instructions to:
receive input data,
buffer the input data,
apply a cascade of size 2×2 max pooling stages to the buffered input data to generate downsampled output data, wherein a stride value of each size 2×2 max pooling stage is determined dynamically in accordance with pooling parameters associated with the size 2×2 max pooling stage, and
output the downsampled output data to another layer of the convolution neural network for further processing.

11. The device of claim 10, wherein the pooling parameters associated with the size 2×2 max pooling stage comprises at least one of a size of input data at the size 2×2 max pooling stage, a window size of the size 2×2 max pooling stage, or an overlap between neighboring windows of the size 2×2 max pooling stage.

12. The device of claim 11, wherein the overlap between the neighboring windows of the size 2×2 max pooling stage is determined in accordance with the size of the input data at the size 2×2 max pooling stage, and the window size of the size 2×2 max pooling stage.

13. The device of claim 10, wherein the one or more processors further execute instructions to determine a size of the buffered input data and a final size of the downsampled output, determine an overlap between neighboring windows of input data of a first size 2×2 max pooling stage in the cascade of size 2×2 max pooling stages, and a window size of the input data of the first size 2×2 max pooling stage, determine a stride S of the first size 2×2 max pooling stage in accordance with the overlap, and the window size, apply the size 2×2 max pooling with stride S kernel to the input data of the first size 2×2 max pooling stage to generate intermediate downsampled output data, save the intermediate downsampled output data, and adjust the size of the input data at the first size 2×2 max pooling stage, the window size of the first size 2×2 max pooling stage, and the overlap between neighboring windows of the first size 2×2 max pooling stage.

14. The device of claim 13, wherein the one or more processors further execute instructions to determine that the overlap between neighboring windows of the input data at the first size 2×2 max pooling stage is equal to zero, and based on the determination that the overlap between neighboring windows of the input data at the first size 2×2 max pooling stage is equal to zero, set the stride S to two, determine that the overlap between neighboring windows of the input data at the first size 2×2 max pooling stage is a first even value and the window size of the first size 2×2 max pooling stage is a second even value, and based on the determination that the overlap between neighboring windows of the input data at the first size 2×2 max pooling stage is a first even value and the window size of the first size 2×2 max pooling stage is a second even value, set the stride S to two, and set the stride S to one for any other possible values of the overlap between neighboring windows of the input data at the first size 2×2 max pooling stage and the window size of the first size 2×2 max pooling stage.

15. The device of claim 14, wherein the one or more processors further execute instructions to determine that the overlap between neighboring windows of the input data at the first size 2×2 max pooling stage is equal to zero and the window size is an odd value, and based on the determination that the overlap between neighboring windows of the input data at the first size 2×2 max pooling stage is equal to zero and the window size is an odd value, add a padding element to each window sized segment of the input data at the first size 2×2 max pooling stage, and adjust the window size and the size of the input data at the first size 2×2 max pooling stage.

16. The device of claim 15, wherein the one or more processors further execute instructions to increment the window size, and adjust the size of the input data at the first size 2×2 max pooling stage in accordance with expression size=size+(size/the window size).

17. The device of claim 13, wherein the one or more processors further execute instructions to adjust the window size in accordance with expression window size=(window size−2)/stride S+1, adjust the size of the input data at the first size 2×2 max pooling stage in accordance with expression size=(size−2)/stride S+1, and adjust the overlap in accordance with expression overlap=(overlap−2)/2+1.

18. The device of claim 13, wherein the one or more processors further execute instructions to repeat the determining the stride S, the applying, the saving, and the adjusting until a size of input data at remaining size 2×2 max pooling stages is equal to the final size.

19. The device of claim 10, wherein the device comprises one of a convolutional neural network (CNN) and a graphics processing unit implementing a CNN.

20. A non-transitory computer-readable media storing computer instructions for performing size K×K max pooling with stride S at a max pooling layer of a convolutional neural network to downsample input data, that when executed by one or more processors, cause the one or more processors to perform the steps of:
receive input data,
buffer the input data,
apply a cascade of size 2×2 max pooling stages to the buffered input data to generate downsampled output data, wherein a stride value of each size 2×2 max pooling stage is determined dynamically in accordance with pooling parameters associated with the size 2×2 max pooling stage, and
output the downsampled output data to another layer of the convolution neural network for further processing.
